(19) United States
(12) Patent Application Publication
(10) Pub. No.: US 2018/0362887 A1
(43) Pub. Date: Dec. 20, 2018

(54) Mold, Mildew, Rust, Tarnish & Lime Remover

(71) Applicant: Gregg A Motsenbocker, San Diego, CA (US)

(72) Inventor: Gregg A Motsenbocker, San Diego, CA (US)

(21) Appl. No.: 15/007,115

(22) Filed: Jan. 26, 2016

(51) Int. Cl. C11D 3/20; C11D 3/50; C11D 3/04; C11D 3/33

(52) U.S. Cl. CPC C11D 3/2086; C11D 3/50; C11D 3/2068; C11D 3/33; C11D 3/042

(57) ABSTRACT

A new formulation designed to lift mold, scale, rust & lime from smooth surfaces is presented which contains less than 3% VOC materials. The composition is non-toxic and easy to apply, including an optional thickened solution to be used for sloping or vertical surfaces, to minimize run-off. Optionally, a proprietary repellancy treatment component can be added to this composition to increase the composition's hydrophobic and oleophobic capabilities after application to surfaces.

### FIELD OF THE INVENTION

Compositions to remove mold, mildew, rust, tarnish, and lime from hard and both low and high porosity surfaces such as glass, metal, stone, tile and brick to restore them as closely as possible to a clean condition.

### BACKGROUND OF THE INVENTION

Surfaces, such as those of stone, and certain metal and metal composites, and other hard surfaces such as tile can be stained with scale, tarnish, or rust, and calcium, mineral deposits and lime from oxidation and water runoff. The above recitation exemplifies a broad range of materials which need to be cleaned from the listed range of deposits and stains. In response to this need, an equally wide range of cleaning compositions already exists in the market.

Generally speaking, commercial compositions to address this problem are limited both in the range of their effectiveness, and also as to how efficient they really are for their intended purpose. In addition, some of the stains and deposits are usually only partially removed after application of market-available cleaners, and with risk to the material being cleaned. Said compositions also possess a strong smell and cannot be used in an enclosed space, and often require protective gloves during application.

On the consumer market today, for example, there is no known composition which will remove scale, lime, or rust without using phosphoric or hydrochloric acid. These chemicals have the disadvantages of bad smell, with the need for ventilation, plus damage to the environment. The present invention avoids these problems.

Furthermore, many existing compositions are objectionable from an environmental standpoint.

### OBJECTS OF THE INVENTION

It is an object of this invention to provide a water-based environmentally acceptable, biodegradable cleaning composition which can be used to remove scale, tarnish, or rust, calcium, mineral deposits and lime. Any residue of these compositions which might remain on the surface will not adversely affect the user or the surface to which it was applied.

This formulation represents a paradigm shift away from traditional cleaners. All cleaners in the market today clean specified substrates, e.g. tile cleaner, bathroom cleaner, floor cleaner, carpet cleaner, pre-wash; this formulation attacks specific stain types, for ANY listed substrate. The formula can be used on fabrics and then washed.

It has proved to be a considerable surprise to observe how many types of really difficult stains and deposits these compositions can remove, with little or no remaining evidence that there ever had been a stain or a deposit, or that the composition ever had been applied, all without damage to the material being cleaned. Note that this composition will not harm Lexan® or Plexiglass®. This composition can also be used on carpet, clothes, and other material as long as they can be rinsed afterwards.

In addition, this composition helps to remove cebum (body oils) and other oils from bathroom surfaces, such as anti-skid surfaces in hotel bathtubs/showers. Another unobvious use is for tarnish removal from silver, brass, and stainless steel items.

This composition is water-based, and is environmentally acceptable, with no chlorine, sodium hypochlorite, or sulfuric acid. Therefore, no protective gear is required and the composition is safe to use in an enclosed space.

It is also the case that traditional formulations for calcium, rust, and tarnish removal do not address mold or mildew. The present invention is a single formulation that handles all of these cleaning problems.

When used to clean bathroom mirror or glass surface, the formulation removes stains that cannot be removed by state-of-the-art cleaners and leaves behind a hydrophobic surface that is optically clear.

Cleaners in today's market are basically just soap and water. This VOC-compliant formulation works better than non-VOC-formulations in the market, remaining safe for the environment, safe for the individual, and safe for any surface.

### BRIEF DESCRIPTION OF THE INVENTION

A composition according to this invention specifically designed to attack and remove scale, lime, and rust is water-based and comprises, in addition to water, Glycol Ether EB, DBE, glycolic acidic, formic, sulfumic, and citric acids and a small amount of fragrance. This composition is surprisingly effective for the removal of scale, lime, and rust on hard surfaces.

Surfaces and stains to be treated include indoor lime, outdoor lime, mildew and mold, and on all surfaces rust and tarnish, including automotive parts and tools.

The formulation optionally possesses an amount of thixotropic or foaming agent, replacing an equal amount of water.

The formulation also optionally possesses an amount of a Proprietary Repellancy Treatment (PRT) that is commercially available and can be added to the formula replacing an equal amount of water. Presently, the PRT selected is from the list of Fiber Shield Krystal-Kleer™, Krystal-Kleer+™, Terracryl™, or Watercryl™ This treatment can be sprayed on with the present formula, provides state-of-the-art water repellancy, and is 100% optically clear.

### DETAILED DESCRIPTION OF THE INVENTION

The basic formulation of this invention, itself useful for cleaning mold, rust, and scale from a wide range of substrate materials, is an aqueous solution of water and the chemicals listed below. This solution is biodegradable, low-no-VOC content and is applicable to a wide range of materials without damaging them. It is best to wash it off after the solution has done its work—it does leave a small but usually unobjectionable deposit. The components of the solution are benign, and if left in place will cause no damage to the substrate to which the solution is applied, or to persons who come in contact with it.

The combination of components used herein appears to function synergistically, by mechanisms which are not fully understood at this time. What has become apparent is that the total composition functions to a degree of effectiveness much greater than already-known compositions useful for the intended purposes, and that elimination of any of the components greatly reduces the effectiveness of the composition.

As a preliminary observation, it should be noted that purified water (either distilled, de-ionized or softened), is preferred. If it is used, the solution will be clear. If water is used which is not purified, then the solution is likely to be cloudy and sometimes less acceptable to the user. However, some users might actually prefer a cloudy or milky composition. Use of tap water will usually result in this.

The modified formulation described herein can be directly applied to many troublesome stains and left there. The stain quickly disappears. There will be no damage to any surfaces.

The addition in an alternate embodiment of coatings amounting to less than 2% of the total formula will confer additional hydrophobic and oleophobic capabilities to the present invention. These coatings are generically a Proprietary Repellancy Treatment (PRT) selected from Fiber Shield Krystal-Kleer™, Krystal-Kleer+™, Terracryl™, or Watercryl™.

The presently preferred basic formulation producing a VOC of 0.05% is as follows:

CAS Numbers

| | |
|---|---|
| De-ionized water | 7732-18-5 |
| Sulfumic Acid | 5329-14-6 |
| Citric Acid | 77-92-9 |
| Glycolic Acidic Acid | 79-14-1 |
| Dowfax 2A1 (anionic surfactant) | 12626-49-2 |
| Tomadol (Nonionic surfactant) | 68131-39-5 |
| Formic Acid | 64-18-6 |
| JL80X (Alcohol alkoxylate) | 68154-97-2 |
| Glycol ether EB (2-Butoxyethanol) | 111-76-2 |
| Glycol ether DPNP | 29911-27-1 |
| (Dipropylene Glycol n-Propyl Ether) | |
| Glycol ether DB | 112-34-5 |
| 2-(2-butoxyethoxy)ethanol | |
| EDTA Versene 100 | 60-00-4 |
| (ethylenediaminetetraacetic acid) | |
| Methocel A15C (Methyl cellulose) | 9004-67-5 |

### Fragrance

In all the the formulations and guidelines given below, at least one substance from each group must be included.

As a variation of the below formula, an amount of thixotropic agent equal to 5.2 percent by weight can be added to each of the formulae, substituting for an equal amount of de-ionized water. As an example, methyl cellulose and fumed silica make excellent thickeners for these compositions.

The following is the preferred embodiment of the solution:

| | |
|---|---|
| De-ionized water | 77.79% |
| Sulfumic Acid | 4.00% |
| Citric Acid | 1.00% |
| Glycolic Acidic Acid | 14.00% |
| Dowfax 2A1 | 1.00% |
| Tomadol | 0.01% |
| Formic Acid | 0.05% |
| JL80X | 0.05% |
| Glycol ether EB | 0.05% |
| EDTA Versene 100 | 2.00% |
| Methocel A15C | |
| Fragrance | 0.05% |

This invention is not to be limited to the embodiments described in the description which are given by way of example and not of limitation, but only in accordance with the scope of the appended claims.

I claim:

1. A water-based composition for removing mold, scale, rust & lime from substrates, with a VOC level of three percent, consisting essentially of:

| | |
|---|---|
| a. De-ionized water | 77.79%; |
| b. Sulfumic Acid | 1.00 to 4.00%; |
| c. Citric Acid | 1.00 to 4.00%; |
| d. Glycolic Acidic Acid | 1.00 to 14.00%; |
| e. anionic surfactant | 1.00%; |
| f. Nonionic surfactant | 0.01%; |
| g. Formic Acid | 0.00 to 0.05%; |
| h. Alcohol alkoxylate | 0.05%; |
| I. 2-Butoxyethanol | 0.05%; |
| j. ethylenediaminetetraacetic acid | 2.00%; |
| k. Fragrance | 0.05%; and |
| l. enough deionized water to make up | 100.0% |

2. A composition for removing mold, scale, rust & lime from surfaces, as in claim 1, where the amount of de-ionized water is replaced with 72.59 percent de-ionized water plus 5.2 percent thixotropic agent, the thixotropic agent selected from methyl cellulose or foamed silica.

3. A composition for removing mold, scale, rust & lime from surfaces, as in claim 1, where the 2-Butoxyethanol is replaced by an equal amount of 2-(2-butoxyethoxy)ethanol.

4. A composition for removing mold, scale, rust & lime from surfaces, as in claim 1, where the 2-Butoxyethanol is replaced by an equal amount of Dipropylene Glycol n-Propyl Ether.

5. A composition for removing mold, scale, rust & lime from surfaces, as in claim 1, where 2.00% of the de-ionized water is replaced with an equal amount of Proprietary Repellancy Treatment (PRT), the PRT selected from Fiber Shield Krystal-Kleer™, Krystal-Kleer+™, Terracryl™, or Watercryl™.
